(19) United States
(12) Patent Application Publication
(10) Pub. No.: US 2014/0185096 A1
(43) Pub. Date: Jul. 3, 2014

(54) IMAGE FORMING SYSTEM AND IMAGE FORMING APPARATUS

(71) Applicant: CANON FINETECH INC., Misato-shi (JP)

(72) Inventor: Seiji Tokunaga, Kashiwa-shi (JP)

(73) Assignee: CANON FINETECH INC., Misato-shi (JP)

(21) Appl. No.: 14/141,921

(22) Filed: Dec. 27, 2013

(30) Foreign Application Priority Data
Dec. 27, 2012 (JP) 2012-285684
Oct. 17, 2013 (JP) 2013-216401

(51) Int. Cl. H04N 1/00; G06F 3/12

(52) U.S. Cl. CPC H04N 1/00976; G06F 3/1211; G06F 3/1229
USPC 358/1.15

(57) ABSTRACT

An image forming system, including a plurality of image forming apparatus mutually connected to one another through a network, each of the plurality of image forming apparatus being configured to form an image on a recording medium, each of the plurality of image forming apparatus including: an environment detecting device configured to detect environmental information of each of the plurality of image forming apparatus; and a control unit configured to control image forming conditions based on the environmental information detected by the environment detecting device, wherein the control unit of one of the plurality of image forming apparatus sets the image forming conditions of the one of the plurality of image forming apparatus based on the environmental information of another of the plurality of image forming apparatus through the network.

### BACKGROUND OF THE INVENTION

1. Field of the Invention

The present invention relates to an image forming system including a plurality of image forming apparatus and to an image forming apparatus.

2. Description of the Related Art

An electrophotographic copying machine is used all over the world, and thus, is required to form an appropriate image under various environments such as a high temperature and high humidity environment or a low temperature and low humidity environment. Therefore, an electrophotographic image forming apparatus includes an environment detecting sensor configured to detect temperature and humidity. Based on information on temperature and humidity detected by the sensors, various printing parameters are changed. Specifically, when the copying machine is used under a high temperature and high humidity environment at, for example, an ambient temperature of 30° C. and a humidity of 80%, in order to prevent paper curling and re-transfer, control is performed to lower the transfer bias and to lower the controlled fixing temperature during printing. When the copying machine is used under a low temperature and low humidity environment at, for example, an ambient temperature of 15° C. and a humidity of 10%, in order to prevent toners on the sheet of paper from being unfixed and to prevent a blank area caused by poor transfer, control is performed to raise the transfer bias and to raise the controlled fixing temperature during printing.

Accordingly, once an inconvenience such as breakage of an environment detecting sensor configured to detect the temperature and the humidity in the apparatus is caused, the poor fixing or the conveyance failure caused by paper curling may occur because a control appropriate for the usage environment cannot be performed. If a sheet of paper to which an image is fixed is overheated in a fixing operation, the curl of the sheet is increased. The curled sheet may be jammed in the apparatus in the course of conveyance of the sheet. If a user pulls forcedly the jammed sheet of paper by hand, a component in the apparatus may be broken. Inventions disclosed in Japanese Patent Application Laid-Open Nos. 2008-009250 and H10-161469 have been made in this context.

Hitherto, as disclosed in Japanese Patent Application Laid-Open No. 2008-009250, a method in which an inconvenience such as failure of an environment detecting sensor is detected and an error indication is provided on an operation panel or the like is well known. However, once an error is detected, the image forming apparatus cannot be used until a serviceman comes and repairs it, and thus, the image forming apparatus is very difficult to use from the viewpoint of usability.

Further, as disclosed in Japanese Patent Application Laid-Open No. H10-161469, another method is also conceivable in which, when a temperature detecting sensor is broken, an average temperature between a controlled fixing temperature under a high temperature and high humidity environment and a controlled fixing temperature under a low temperature and low humidity is obtained. For example, with regard to a fixing device in which the controlled fixing temperature under a high temperature and high humidity environment is set to be 180° C. and the controlled fixing temperature under a low temperature and low humidity environment is set to be 210° C., when an environment detecting sensor fails, the average temperature of the both controlled fixing temperatures is obtained, and sheets of paper are passed through the fixing device with the controlled fixing temperature of 195° C. being set under any environment. However, in this method, a sheet of paper is passed through the fixing device at the controlled fixing temperature of 195° C. even under a high temperature and high humidity environment. The temperature difference is 15° C. from the controlled fixing temperature of 180° C. which should be, originally, set under a high temperature and high humidity environment. With regard to a sheet of paper which contains ample moisture under a high temperature and high humidity environment, increase in the curl due to 15° C. rise of the controlled fixing temperature is very large, and adverse effects such as a jam due to a big curl may be caused. Similarly, a sheet of paper is passed through the fixing device at 195° C. even under a low temperature and low humidity environment. The temperature difference is 15° C. from the controlled fixing temperature of 210° C. which should be, originally, set under a low temperature and low humidity environment. With regard to a sheet of paper which is amply cooled under a low temperature and low humidity environment, insufficient heating due to 15° C. drop of the controlled fixing temperature is serious, and for example, image quality may be lowered due to poor fixing and conveyance of a sheet of paper with poor fixing may cause the inside of the apparatus to be dirty due to unfixed toner.

Further, as a well-known measure, it is also conceivable to pass all sheets of paper through the fixing device under image forming conditions which are to be set under a normal temperature and normal humidity environment when the environment detecting sensor fails. For example, with regard to a fixing device in which the controlled fixing temperature under a high temperature and high humidity environment is set to be 180° C., the controlled fixing temperature under a low temperature and low humidity environment is set to be 210° C., and the controlled fixing temperature under a normal temperature and normal humidity environment is set to be 200° C., when an environment detecting sensor fails, a sheet of paper is passed through the fixing device at the controlled fixing temperature of 200° C. under any environment. The temperature difference is 20° C. from the controlled fixing temperature of 180° C. which should be, originally, set under a high temperature and high humidity environment. With regard to a sheet of paper which contains ample moisture under a high temperature and high humidity environment, increase in the curl amount due to 20° C. rise of the controlled fixing temperature is very large, and adverse effects such as a jam due to a big curl may be caused. Similarly, a sheet of paper is passed through the fixing device at 200° C. even under a low temperature and low humidity environment. The temperature difference is 10° C. from the controlled fixing temperature of 210° C. which should be, originally, set under a low temperature and low humidity environment. With regard to a sheet of paper which is amply cooled under a low temperature and low humidity environment, the heating is insufficient due to 10° C. drop of the controlled fixing temperature, and for example, image quality may be lowered due to poor fixing and conveyance of a sheet of paper with poor fixing may cause the inside of the apparatus to be dirty due to unfixed toner.

In order to avoid such a situation, it is desirable that, even when inconvenience is caused in an environment detecting sensor (environment detecting device) of an image forming apparatus, image forming conditions be able to be set in accordance with the usage environment.

### SUMMARY OF THE INVENTION

An object of the present invention is to provide an image forming system and an image forming apparatus which can, even when environmental information of an environment detecting device cannot be used in the image forming apparatus, set image forming conditions of the image forming apparatus based on environmental information of an environment detecting device of another image forming apparatus.

In order to achieve the above-mentioned object, according to one embodiment of the present invention, there is provided an image forming system including a plurality of image forming apparatus mutually connected to one another through a network, each the plurality of image forming apparatus being configured to form an image on a recording medium, each of the plurality of image forming apparatus including: an environment detecting device configured to detect environmental information of each of the plurality of image forming apparatus; and a control unit configured to control image forming conditions based on the environmental information detected by the environment detecting device, wherein the control unit of one of the plurality of image forming apparatus sets the image forming conditions of the one of the plurality of image forming apparatus based on the environmental information of another of the plurality of image forming apparatus through the network.

According to one embodiment of the present invention, there is provided an image forming apparatus configured to form an image on a recording medium, the image forming apparatus including: an environment detecting device configured to detect environmental information of the image forming apparatus; a control unit configured to control image forming conditions based on the environmental information detected by the environment detecting device; and a communication device configured to obtain at least the environmental information from another image forming apparatus, wherein the control unit sets the image forming conditions based on environmental information of the another image forming apparatus through the communication device.

Further features of the present invention will become apparent from the following description of exemplary embodiments with reference to the attached drawings.

### BRIEF DESCRIPTION OF THE DRAWINGS

FIG. 1 is a sectional view illustrating a configuration of an image forming apparatus according to an embodiment of the present invention.

FIG. 2A is a block diagram of a main body control portion.

FIG. 2B is a schematic view illustrating information transmission between environment detecting devices of a copying machine A and a copying machine B.

FIG. 2C is a table showing the relationship between detected voltage by the environment detecting device and environmental temperature.

FIG. 3 is a flowchart illustrating control steps in the main body control portion.

FIG. 4 is a flowchart illustrating control steps in the main body control portion according to Embodiment 3.

FIG. 5 is a schematic view illustrating a state of transmitting and receiving environmental data when the copying machine A is under a low temperature and low humidity environment and the copying machine B is under a high temperature and high humidity environment.

FIG. 6 is a schematic view illustrating a state in which four copying machines A to D are connected to a cloud server through a network.

### DESCRIPTION OF THE EMBODIMENTS

Exemplary embodiments of the present invention will be described in the following in detail with reference to the accompanying drawings. However, the dimensions, materials, shapes, relative positional relationship, and the like of structural elements described in the embodiments are appropriately changed depending on the structure of the apparatus to which the present invention is applied and various conditions, and thus, these are not meant to limit thereto the scope of the present invention unless otherwise specified.

### Embodiment 1

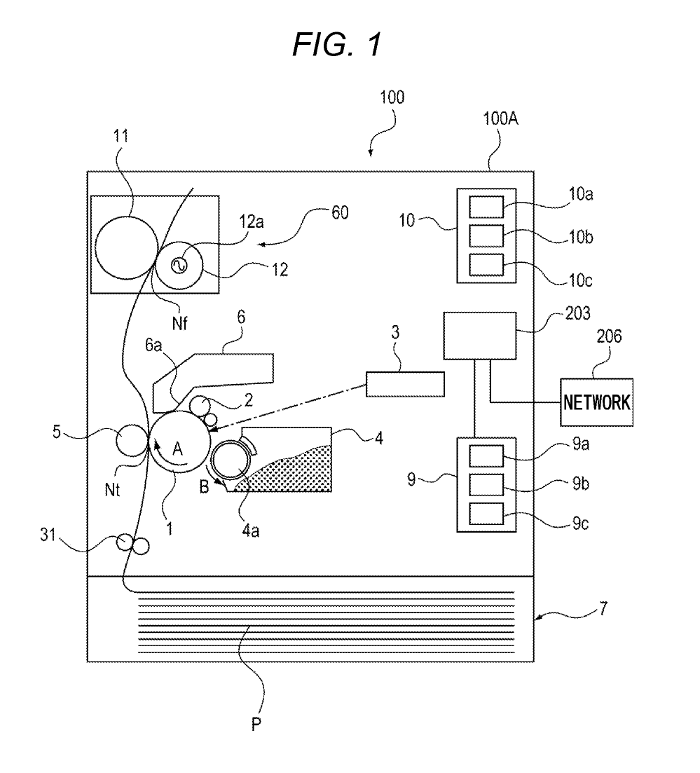

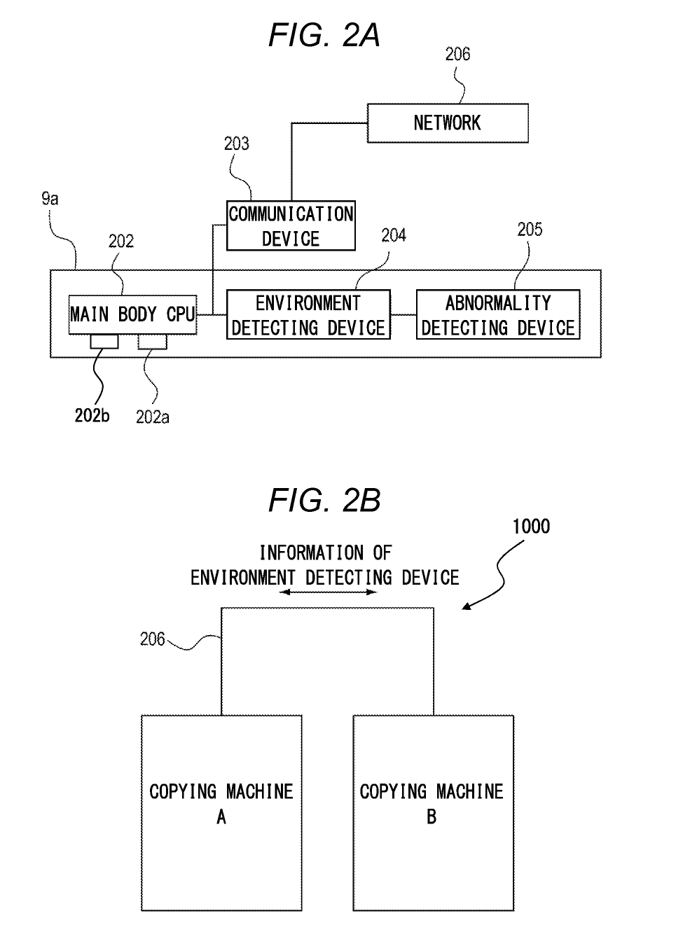

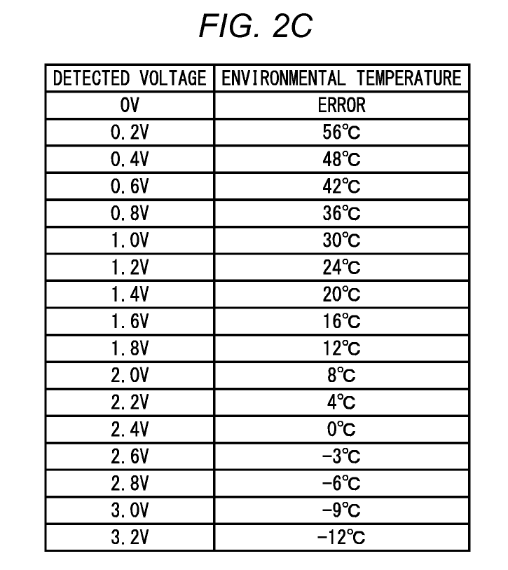

FIG. 1 is a sectional view illustrating a configuration of an image forming apparatus 100 according to an embodiment of the present invention. The image forming apparatus 100 includes an apparatus main body 100A. A photosensitive drum 1 is disposed in the apparatus main body 100A. A charging roller 2, a laser scanner 3, a developing device 4 including a development roller 4a as a developer carrying member, a transfer roller 5, and a cleaning device 6 including a cleaning blade 6a are disposed around the photosensitive drum 1. An image forming system 1000 (see FIG. 2B) includes a plurality of image forming apparatus 100 (in FIG. 2B, illustrated as copying machines A and B) connected to one another through a network 206 (see FIGS. 2A and 2B). The network 206 as used herein is a local area network (LAN) inside a company or the like, or an external network configured to communicate with outside through the Internet or the like.

A surface of the photosensitive drum 1 is uniformly charged by the charging roller 2, an electrostatic image is formed on the surface of the photosensitive drum 1 by the laser scanner 3, and the image is developed with a developer by the developing device 4. The developer image on the surface of the photosensitive drum 1 is transferred onto a sheet P by the transfer roller 5.

A cassette 7 configured to contain the sheet P is disposed in the lower portion of the apparatus main body 100A. The sheet P in the cassette 7 is discharged after passing through a conveyance roller pair 31, a nip portion Nt between the photosensitive drum 1 and the transfer roller 5, and a fixing device 60. The fixing device 60 as a fixing unit includes a fuser roller 12 and a pressure roller 11. A heater 12a is disposed in the fuser roller 12.

Further, a control board 9 as a control unit configured to control image forming operation and a high voltage board 10 configured to apply high voltage to the charging roller 2, the developing device 4, and the like are disposed at the back of the apparatus main body 100A. The control board 9 includes a main body control portion 9a including a main body CPU and the like, a fixing control portion 9b, and a memory (storage device) 9c. The main body control portion 9a is a configured to issue a command for executing image forming operation or the like. The fixing control portion 9b is configured to execute control of a fixing temperature and the like. The memory 9c is configured to store programs and the like.

The high voltage board 10 includes a charge application power source 10a, a development application power source 10b, and a transfer application power source 10c. The charge application power source 10a includes a direct current power source and an alternating current power source. The development application power source 10b includes a direct current power source and an alternating current power source. The transfer application power source 10c includes a positive direct current power source and a negative direct current power source. Various kinds of control of operation of the image forming apparatus (printers) are performed by the main body control portion 9a and the fixing control portion 9b of the control board 9 reading necessary programs from the memory (storage device) 9c of the control board 9.

FIG. 2A is a block diagram of the main body control portion 9a of each of the image forming apparatus 100 configured to form an image on the sheet P as a recording medium. The main body control portion 9a includes a main body CPU 202, an environment detecting device 204 (environment detecting sensor), and an abnormality detecting device 205. A communication device 203 connected to the main body control portion 9a is configured to be connected to the network 206. The environment detecting device 204 is a device configured to detect the temperature and the humidity in the apparatus main body 100A as environmental information.

The abnormality detecting device 205 as a failure detecting unit is configured to detect failure of the environment detecting device 204. The main body CPU 202 as a control unit transmits and receives the temperature and the humidity which the environment detecting device 204 detects, and positional information of the apparatus main body 100A held by a holding portion 202a from another image forming apparatus 100 through the communication device 203 and the network 206. The holding portion 202a as a holding unit holds the positional information of the apparatus main body 100A. The positional information held by the holding portion 202a may be registered by a serviceman or a user when the main body is set, or, may be obtained using a GPS including a CPU as a control unit of the image forming apparatus 100. A storage portion 202b as a storage unit stores environmental information such as the temperature and the humidity in the apparatus main body 100A.

The main body control portion 9a is connected to the network 206, and thus, the main body CPU 202 is connectable to the network 206 through the communication device 203. The main body CPU 202 has the holding portion 202a configured to hold the positional information of the apparatus main body 100A and the storage portion 202b both mounted thereto. The main body CPU 202 controls driving of inner devices in the apparatus main body 100A.

As illustrated in FIG. 2A, a print command is sent from the network 206 through the communication device 203 to the main body CPU 202. The main body CPU 202 determines image forming conditions based on the data of the temperature and the humidity detected by the environment detecting device 204. For example, when the environment detecting device 204 detects that the temperature is 30° C. and the humidity is 80%, the main body CPU 202 sets the image forming conditions including, for example, a fixing bias of −500 V, a transfer bias of 2 kV, and a controlled fixing temperature of 180° C.

In this case, when the abnormality detecting device 205 detects failure of the environment detecting device 204 (when the environmental information of the environment detecting device 204 cannot be used), the main body CPU 202 selects another image forming apparatus 100 from positional information of the another image forming apparatus 100 through the network 206. The main body CPU 202 sets the image forming conditions based on the environmental information of the another image forming apparatus 100.

Note that, when there are a plurality of other image forming apparatus, the main body CPU 202 determines which image forming apparatus is to be selected to use the environmental information thereof based on the positional information. In this case, the environmental information of the closest image forming apparatus 100 is preferentially selected and used, but the present invention is not limited thereto, and the setting may be such that the positional information of other image forming apparatus 100 are used. For example, an image forming apparatus installed on the same floor where the environment is thought to be the same because of the operation of an air conditioner may be preferentially selected even though the image forming apparatus is farther than an image forming apparatus installed on another floor, or, an image forming apparatus of the same model or of the same series in which the environment detecting device 204 is disposed in the same location as the faulty environment detecting device 204 of the image forming apparatus 100 may be preferentially selected.

The image forming conditions as used herein comprise values (set values), which are set in forming an image, such as a charging bias which is applied to the charging roller 2 as a charging device, the transfer bias which is applied to the transfer roller 5 as a transfer device, a developing bias which is applied to the development roller 4a of the developing device 4, the fixing bias which is applied to the fixing device 60, and the controlled fixing temperature of the fixing device 60.

FIG. 2B is a schematic view illustrating a state in which information of the environment detecting devices 204 are exchanged between a first image forming apparatus (in FIG. 2B, copying machine A) and a second image forming apparatus (in FIG. 2B, copying machine B). A system having a plurality of copying machines such as the copying machine A and the copying machine B as described above is hereinafter referred to as image forming system 1000. As illustrated in FIG. 2B, the copying machine A and the copying machine B always establish P to P communication. In the embodiment, a communication system using a cable LAN is used, but other communication systems such as wireless Wi-Fi or Bluetooth (trademark) may also be used.

The abnormality detecting device 205 detects whether the environment detecting device 204 is normal or abnormal. FIG. 2C is a conversion table of detected voltage and temperature of the environment detecting device 204. The resistance value of the environment detecting device 204 varies depending on the temperature, and thus, the environmental temperature is known by reading the voltage value applied to the environment detecting device 204. The electrical resistance value of the environment detecting device 204 is a finite value, and thus, a detected value of 0 V is ordinarily impossible. The value is 0 V only when there is a break in the environment detecting device 204. Therefore, when such a detected value is obtained, the environment detecting device 204 is determined to be in failure.

Table 1 shows data of the temperature and the humidity of the copying machine A and the copying machine B at 7:00 on November 21 (Mon). The environmental information can be exchanged between the copying machine A and the copying machine B. For example, the data of the temperature and the humidity shown in Table 1 can be referred to mutually. Table 1 shows a state in which the data of the temperature and the humidity at 7:00 on November 21 (Mon) is recorded. With regard to the copying machine A, the temperature is 20° C. and the humidity is 48%. With regard to the copying machine B, the temperature is 22° C. and the humidity is 51%.

TABLE 1
Data of Temperature and Humidity at 7:00
on November 21 (Mon)

| | Copying machine A | Copying machine B |
|---|---|---|
| Temperature | 20° C. | 22° C. |
| Humidity | 48% | 51% |

Which of the copying machines (image forming apparatus) can exchange environmental information can be set at the time of installation, or later by a serviceman or a user. This setting eliminates the necessity of the positional information of the image forming apparatus, and thus, the necessity of control steps of selecting environmental information of an image forming apparatus and the like and a storage unit for the positional information is eliminated. The image forming conditions of the copying machines whose environmental information is set to be exchanged are changed based on the environmental information. For example, when the environmental information of the other image forming apparatus is that the ambient temperature is 30° C. and the humidity is 80%, based on the environmental information, the controlled fixing temperature of the fixing device 60 is set to be 180° C. and the transfer bias is set to be 2 kV. Similarly, when the environmental information of the other image forming apparatus is that the ambient temperature is 10° C. and the humidity is 10%, based on the environmental information, the controlled fixing temperature of the fixing device 60 is set to be 200° C. and the transfer bias is set to be 2.5 kV.

Table 2 shows data of the temperature and the humidity of the copying machine A and the copying machine B at 12:45 on November 22 (Tue). As shown in Table 2, a case in which the environment detecting device 204 of the copying machine A fails is assumed.

TABLE 2
Data of Temperature and Humidity at
12:45 on November 22 (Tue) (in failure)

| | Copying machine A | Copying machine B |
|---|---|---|
| Temperature | Failure | 30° C. |
| Humidity | Failure | 75% |

Table 3 shows data of the temperature and the humidity of the environment detecting device 204 after the copying machine A is restored when the environment detecting device of the copying machine A fails at 12:45 on November 22 (Tue). As shown in Table 3, the copying machine A establishes intercommunication with the copying machine B, and reads the data of the temperature and the humidity of the copying machine B. The main body CPU 202 as a control device of the image forming apparatus 100 of the copying machine A receives a print command or a copy command from a user. At this time, when failure of the environment detecting device 204 is detected, the image forming conditions are set based on the environmental information such as the temperature and the humidity detected by the environment detecting device 204 of the image forming apparatus 100 of the copying machine B. Further, when the power source of the copying machine B is turned off, measures such as setting the image forming conditions based on the environmental information of the copying machine A at the same time on the previous day or informing the user of an instruction to turn on the power source of the copying machine B are conceivable.

TABLE 3
Temperature at 12:45 on November 22
(Tue) (after restoration)

| | Copying machine A | Copying machine B |
|---|---|---|
| Temperature | 30° C. | 30° C. |
| Humidity | 75% | 75% |

When the environment detecting device of the copying machine A fails on November 22, the environmental information of the copying machine B which is set in advance is read.

In this case, the main body CPU 202 recognizes, from the environmental information of the copying machine B, that the copying machine A is under a high temperature and high humidity environment, and sets the controlled fixing temperature of the fixing device 60 to 180° C. and sets the transfer bias to 2 kV to form an image.

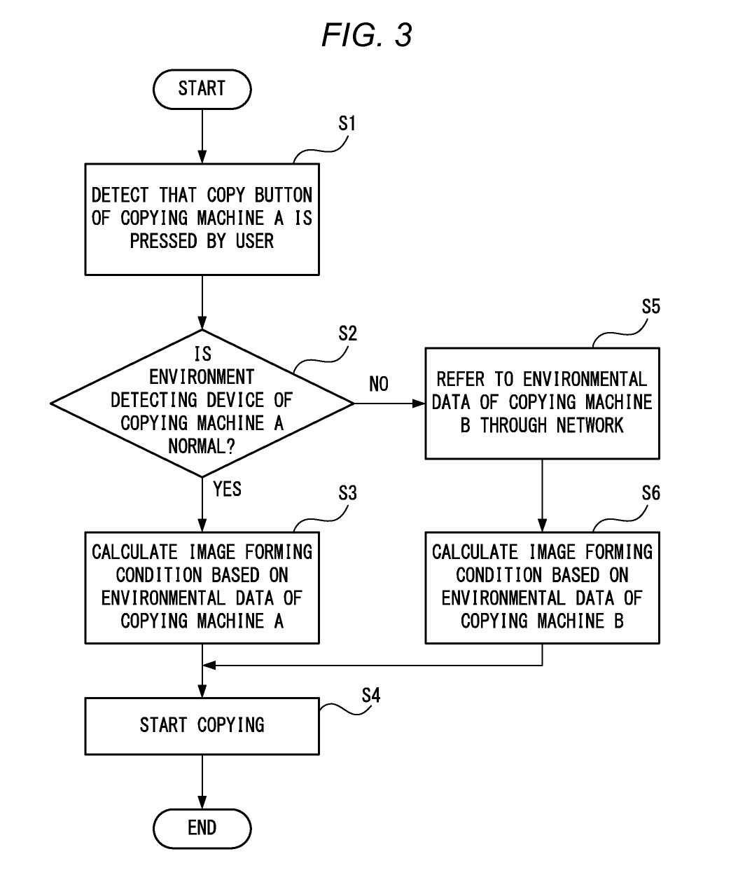

FIG. 3 is a flowchart illustrating control steps in the main body CPU 202. As illustrated in FIG. 3, the main body CPU 202 detects that a COPY button of the copying machine A is pressed by a user (instead of this, a print command may be issued to the copying machine A through the network) (S1). The main body CPU 202 determines whether the environment detecting device 204 of the copying machine A normally operates or not (S2).

When the result of the determination in S2 is YES (the environment detecting device 204 is normal as in Table 1), the main body CPU 202 calculates the image forming conditions based on the environmental data of the copying machine A (S3), feeds a sheet of paper, and starts copying (S4).

When the result of the determination in S2 is NO (the environment detecting device 204 is in failure as in Table 2), the main body CPU 202 regards the environmental data of the temperature and the humidity of the copying machine B in intercommunication with the copying machine A through the network 206 as the environmental data of the copying machine A (S5), and, based on the environmental data, calculates the image forming conditions (S6).

In this way, even when inconvenience such as failure of the environment detecting device 204 configured to detect the temperature and the humidity is caused and the environmental information itself cannot be used, by mutual backup, failure of the copying machine as a whole can be prevented to improve the usability, and failure due to frequent paper jams caused by normal control although the environment is a high temperature and high humidity environment can be inhibited. Further, in this case, only the transfer bias and the controlled fixing temperature are changed in accordance with the environment, but other image forming conditions such as the charging bias and the developing bias with regard to the image formation may also be changed.

### Embodiment 2

In Embodiment 2, the main body CPU 202 of an image forming apparatus 100 obtains, from the environmental information of the storage portion 202b (see FIG. 2A) of the other image forming apparatus 100, a related past day which offers the same data as or data close to the environmental information of the day, and sets the image forming conditions based on the environmental information stored in the storage portion 202b of the image forming apparatus 100 on the obtained day.

Specifically, when the temperature is 22° C. and the humidity is 51% as the environmental information of the day of the copying machine B, the copying machine B selects, among data in the past of the copying machine B, a day on which the temperature and the humidity were equivalent or close thereto, and sends the selected day to the copying machine A. The copying machine A reads data of the environmental information on the obtained day from the storage unit of the copying machine A, and sets the image forming conditions based on the environmental information. The reason is that the relationship between the environmental conditions of the copying machine A and the environmental conditions of the copying machine B on the day is thought to be equivalent to the relationship between the environmental conditions of the copying machine A and the environmental conditions of the copying machine B on the past day.

### Embodiment 3

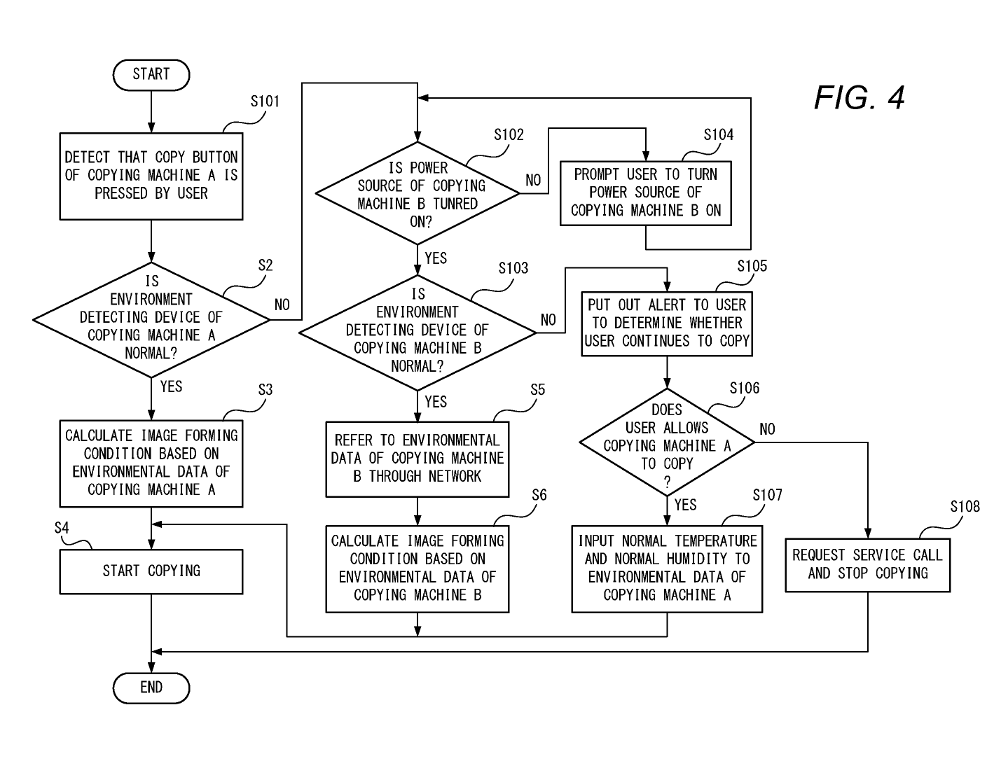

FIG. 4 is a flowchart illustrating control steps in the main body CPU 202 of the main body control portion 9a according to Embodiment 3. The control illustrated in FIG. 4 is basically similar to that of Embodiment 1, but, in Embodiment 3, control is performed that can cope with a case in which both the environment detecting device 204 of the copying machine A and the environment detecting device 204 of the copying machine B are in failure or a case in which the power source of the copying machine B is turned off.

As illustrated in FIG. 4, the main body CPU 202 recognizes that a user presses the COPY button of the copying machine A (S101). The main body CPU 202 determines whether the environment detecting device 204 of the copying machine A is normal or not (S2). When the result of the determination in S2 is YES (the environment detecting device 204 is determined to be normal), the main body CPU 202 calculates the image forming conditions based on the environmental data of the copying machine A (S3), and starts copying (S4). When the result of the determination in S2 is NO (the environment detecting device 204 is in failure), the main body CPU 202 determines whether the power source of the copying machine B is turned on or not (S102).

When the result of the determination in S102 is YES (the power source of the copying machine B is turned on), the main body CPU 202 determines whether the environment detecting device 204 of the copying machine B is normal or not (S103). When the result of the determination in S103 is YES, the main body CPU 202 refers to the environmental data of the copying machine B through the network (S5), and calculates the image forming conditions based on the environmental data of the copying machine B (S6).

When the result of the determination in S102 is NO (the power source of the copying machine B is turned off), the main body CPU 202 prompts the user to turn on the power source of the copying machine B (S104). When the result of the determination in S103 is NO (the environment detecting device 204 of the copying machine B is also in failure), the main body CPU 202 puts out an alert to determine whether the user wants to continue copying (S105).

After S105, the main body CPU 202 determines whether allowance by the user of the copying is received or not (S106). When the result of the determination in S106 is YES, the main body CPU 202 introduces a normal temperature and normal humidity condition as the environmental data of the normal copying machine A (S107). When the result of the determination in S106 is NO, the main body CPU 202 requests a service call and stops copying (S108).

### Embodiment 4

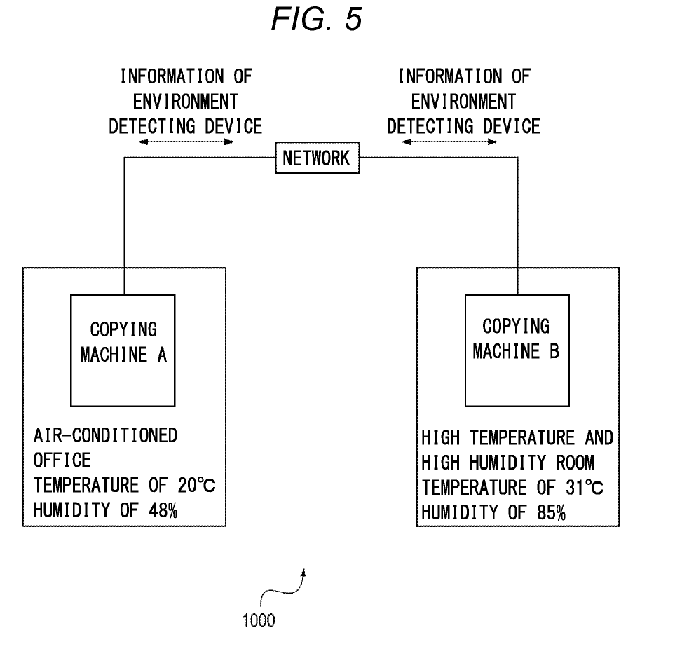

FIG. 5 is a schematic view illustrating a state of transmitting and receiving environmental data when the copying machine A is under a low temperature and low humidity environment and the copying machine B is under a high temperature and high humidity environment. As illustrated in FIG. 5, a case in which the closest copying machines are under completely different environments, for example, a case in which one of two copying machines is located in an air-conditioned room and the other is located in an ill-ventilated sunny southern room is assumed. In such a case, the temperature and the humidity greatly differ between the two copying machines, and, when the environmental data of the other copying machine are used, temperature and humidity which are different from those under the environment in which the one copying machine is actually used may be adopted. In order to accommodate such a case, operation shown in Table 4 and Table 5 is effected.

TABLE 4
Data of Temperature and Humidity at
12:00 on November 21 (Mon)

| | Copying machine | Copying machine | |
|---|---|---|---|
| | A | B | Difference |
| Temperature | 20° C. | 31° C. | −11° C. |
| Humidity | 48% | 85% | −37% |

TABLE 5
Data of Temperature and Humidity at
12:45 on November 22 (Tue) (in failure)

| | Copying machine | Copying machine | |
|---|---|---|---|
| | A | B | Difference |
| Temperature | Failure | 30° C. | Unknown |
| Humidity | Failure | 75% | Unknown |

Table 4 shows the data of the temperature and the humidity at 12:00 on November 21 (Mon). Table 5 shows the data of the temperature and the humidity at 12:45 on November 22 (Tue). As shown in Table 4, the differences in temperature and humidity between the copying machine A and the copying machine B are stored, and, based on the stored data, the environmental information is corrected. As shown in Table 4, on November 21, the copying machine A is under a normal temperature and normal humidity environment, and the copying machine B is under a high temperature and high humidity environment. The copying machine A is different from the copying machine B by −11° C. in temperature and by −37% in humidity.

In this way, the main body CPU 202 can calculate the differences between the temperatures and the humidities detected by the environment detecting device 204 of any one of the image forming apparatus 100 and the environment detecting device 204 of any one of the other image forming apparatus 100.

As shown in Table 5, when the environment detecting device 204 of the copying machine A fails at 12:45 on November 22 (Tue), the differences between the temperatures and the humidities detected by the copying machine A and the copying machine B cannot be derived. In this case, if possible, the closest data of the temperature and the humidity are used. Specifically, when the environment detecting device 204 of the copying machine A fails on November 22, that is, on the day following November 21 (Table 5), the newest data of the differences in temperature and humidity between the copying machine A and the copying machine B (in this case, data on November 21) is referred to. Then, the differences in temperature and humidity in the data on November 21 are added to the data of the temperature and the humidity of the copying machine B at present. The result obtained after these corrections are made is shown in Table 6.

TABLE 6
Temperature at 12:45 on November 22
(Tue) (after restoration)

| | Copying machine | Copying machine | Correction |
|---|---|---|---|
| | A | B | value |
| Temperature | 19° C. | 30° C. | −11° C. |
| Humidity | 38% | 75% | −37% |

In the case of failure, the differences between the copying machine A and the copying machine B in the same time frame as and on the previous day to those of the copy command are read, and the read differences are added to the environmental information of the copying machine B at present.

In this way, when the environment detecting device 204 fails and the environment detecting device 204 is not in failure in the other image forming apparatus 100, the main body CPU 202 sets the image forming conditions based on the temperature and the humidity which are the sums of the temperature and the humidity detected by the environment detecting device 204 of the other image forming apparatus 100 and the differences, respectively. The embodiment is different from Embodiment 1 only in that corrections are made to the data of the temperature and the humidity of the copying machine B, and, as the flowchart of the operation, one similar to that in Embodiment 1 may be used.

With regard to the actual correction values, not only the closest environmental data such as that on the previous day but also the average differences in temperature and humidity between the copying machine A and the copying machine B in operation from the time of installation to the time of failure may be used. For example, on the first day in operation, the difference in temperature between the copying machine A and the copying machine B is 10° C., and, on the second day in operation, the difference in temperature between the copying machine A and the copying machine B is 12° C. In this case, when the failure occurs on the third day in operation, the correction is made with the difference being the average of the first day and the second day, that is, the average of 10° C. and 12° C., which is 11° C. Further, the time frame may be focused on. Specifically, when the time at which a copy start command is issued is, for example, 14:30, the correction may be made referring to the environmental information at 14:00, which is in the same time frame, on the previous day.

### Embodiment 5

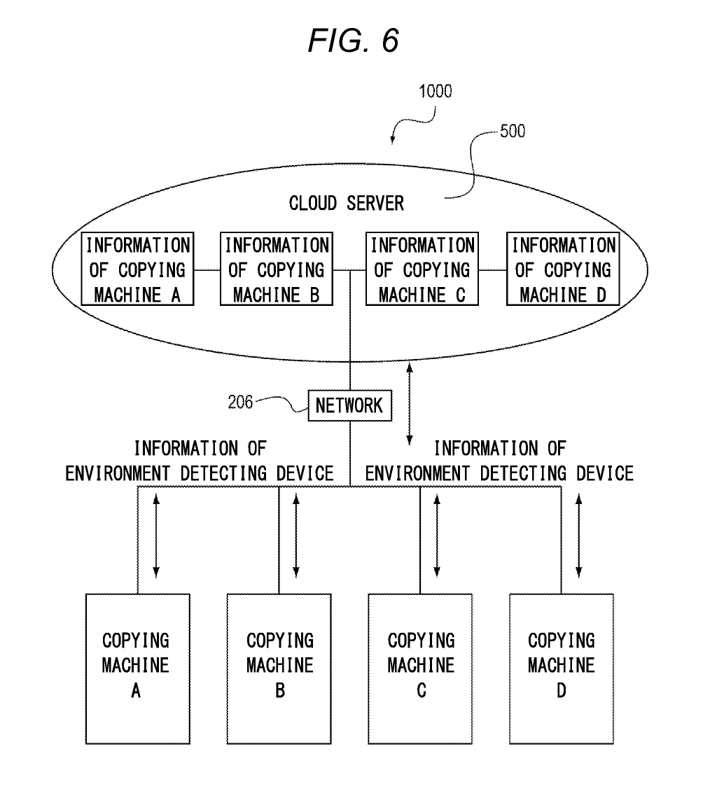

FIG. 6 is a schematic view illustrating a state in which four copying machines A, B, C and D are connected to a cloud server through a network. The detection accuracy in Embodiment 1 to Embodiment 4 is further improved. As illustrated in FIG. 6, the plurality of copying machines are configured to intercommunicate with one another through the network, and a recording medium configured to periodically store the environmental data of each copying machine is provided.

In the embodiment, the main body CPUs of the main body control portions of the copying machines A to D send information of the environment detecting devices 204 to a cloud server 500 illustrated in FIG. 6 at predetermined times (for example, 7:00 a.m., 8:00 a.m., 9:00 a.m., and so on). The cloud server 500 as a storage unit holds the information in the server for a predetermined time period (for example, for a year). When a print command or a copy command is issued to the copying machine A in a state in which the environment detecting device 204 of the copying machine A is in failure, information of another copying machine (for example, the copying machine B) at the newest time stored on the cloud server 500 is received by the main body CPU of the copying machine A. After the difference between the two is taken, the information is reflected in the image forming conditions.

Table 7 to Table 9 show an example of conditions under which the difference is obtained. When the environment detecting device 204 of the copying machine A fails on November 22 (Tue), and a copy command or a print command is issued at 12:45 (Table 8), the main body CPU refers to the data (Table 7) at the closest time (in this case, 13:00) to the time at which the copy command or the print command is sent (12:45) on the closest day (November 21 (Mon)).

TABLE 7
Data of Temperature and Humidity at
13:00 on November 21 (Mon)

| | Copying | Copying | Copying | Copying |
|---|---|---|---|---|
| | machine A | machine B | machine C | machine D |
| Temperature | 20° C. | 25° C. | 31° C. | 18° C. |
| Humidity | 60% | 50% | 78% | 35% |

TABLE 8
Data of Temperature and Humidity at
12:45 on November 22 (Tue) (in failure)

| | Copying | Copying | Copying | Copying |
|---|---|---|---|---|
| | machine A | machine B | machine C | machine D |
| Temperature | Failure | 27° C. | 30° C. | 18° C. |
| Humidity | Failure | 44% | 72% | 35% |

TABLE 9
Data of Temperature and Humidity at
12:45 on November 22 (Tue) (after restoration)

| | Copying | Copying | Copying | Copying |
|---|---|---|---|---|
| | machine A | machine B | machine C | machine D |
| Temperature | 22° C. | 27° C. | 30° C. | 18° C. |
| Humidity | 54% | 44% | 72% | 35% |

When the environment detecting device of the copying machine A fails on November 22, data on the closest day (November 21) at the same time is referred to.

Data of the copying machine B having the smallest differences in temperature and humidity from the copying machine A on November 21 is received.

On November 21, the ambient temperature of the copying machine A is lower than that of the copying machine B by 5° C., and the humidity of the copying machine A is higher than that of the copying machine B by 10%, and thus, the data of the temperature and the humidity of the copying machine A on November 22 is restored in a state in which the temperature of the copying machine A is lower than that of the copying machine B on November 22 by 5° C. and the humidity of the copying machine A is higher than that of the copying machine B on November 22 by 10%.

In this case, with regard to the data on November 21, both the temperature of the copying machine B and the humidity of the copying machine B are closest to those of the copying machine A, and thus, the differences in temperature and humidity at 13:00 on November 21 between the copying machine A and the copying machine B are obtained. In this case, the temperature of the copying machine A is lower than that of the copying machine B by 5° C., and the humidity of the copying machine A is higher than that of the copying machine B by 10%. At 12:45 on November 22 (Tue), the temperature and the humidity of the copying machine B are 27° C. and 44%, respectively, and the differences between the copying machine A and the copying machine B (−5° C. in temperature and +10% in humidity) are added thereto to apply the temperature of 22° C. and the humidity of 54% as the data of the copying machine A at present (Table 9). In this way, in the embodiment, with regard to the environmental information of an image forming apparatus 100 whose environment detecting device cannot be used and another image forming apparatus 100, data stored in the cloud server 500 as the storage unit is used to estimate current temperature and humidity of the image forming apparatus 100 whose environment detecting device cannot be used, and the image forming conditions of the image forming apparatus 100 are set.

In Embodiment 5, the storing device is a cloud server, but the storing device may be any device insofar as the device can store the environmental data. For example, an NAS or a file server may also be used.

According to the configuration of the embodiment, even when the environmental information of the environment detecting device 204 of an image forming apparatus cannot be used, the image forming conditions of the image forming apparatus can be set based on the environmental information of the environment detecting device 204 of another image forming apparatus.

Specifically, when the environment detecting device 204 of a copying machine fails, reduced usability due to error detection, phenomena relating to the life of the apparatus such as a paper jam and wrapping of paper around a drum due to a bigger curl, and further, a situation in which different kinds of control are performed depending on the environment due to such phenomena can be reduced. For example, a large number of adverse effects can be eliminated including adverse effects on an image due to poor transfer, an excessive amount of toner on the image, and the like, and dirt in the apparatus and on recording paper due to poor fixing. In addition, the number of times the copying machine becomes unworkable due to the unavailability of an image forming apparatus therein because of an error is reduced, and thus, a contribution can be made to improvement of an MTBF.

Several embodiments are described in the above, but the present invention is not limited thereto, and various modifications are possible insofar as the environment detecting device 204 configured to determine the image forming conditions is disposed in some location in the image forming apparatus and the information therefrom can be mutually communicated. Further, for example, as illustrated in FIG. 6, the cloud server 500 may store the environmental conditions (the temperatures and the humidities) of the respective copying machines A to D. Further, as illustrated in FIG. 2A, the storage portion 202b of the main body CPU 202 of each of the copying machines A to D may store the environmental conditions (the temperature and the humidity) and the copying machines A to D may establish in direct intercommunication with one another.

Further, the environment detecting device 204 may detect not only the temperature and the humidity, but may detect any data insofar as the data is environmental data reflected in the image forming conditions such as vibrations, dust particles, and the atmospheric pressure. Further, it goes without saying that the present invention is not limited to an electrophotographic apparatus and is applicable to all kinds of apparatus configured to form an image.

According to the embodiments described above, even when the environmental information of the environment detecting device of an image forming apparatus cannot be used, the image forming conditions of the image forming apparatus can be set based on the environmental information of the environment detecting device of another image forming apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2012-285684, filed Dec. 27, 2012, and No. 2013-216401, filed Oct. 17, 2013, which are hereby incorporated by reference herein in their entirety.

What is claimed is:

1. An image forming system, comprising a plurality of image forming apparatus mutually connected to one another through a network,
each of the plurality of image forming apparatus being configured to form an image on a recording medium, each of the plurality of image forming apparatus comprising:
an environment detecting device configured to detect environmental information of each of the plurality of image forming apparatus; and
a control unit configured to control image forming conditions based on the environmental information detected by the environment detecting device,
wherein the control unit of one of the plurality of image forming apparatus sets the image forming conditions of the one of the plurality of image forming apparatus based on the environmental information of another of the plurality of image forming apparatus through the network.

2. An image forming system according to claim 1, wherein the control unit comprises a storage unit configured to store the environmental information detected by the environment detecting device, and
wherein the control unit sets the image forming conditions of the one of the plurality of image forming apparatus based on the environmental information stored in the storage unit of the one of the plurality of image forming apparatus on a day related to the environmental information of a day which is determined from the environmental information detected by the environment detecting device of the another of the plurality of image forming apparatus and the environmental information stored in the storage unit of the another of the plurality of image forming apparatus.

3. An image forming system according to claim 1, wherein the image forming apparatus comprises a holding unit configured to hold positional information of the main body, and
wherein the control unit selects the another of the plurality of image forming apparatus based on the positional information and sets the image forming conditions of the one of the plurality of image forming apparatus based on the environmental information of the selected another of the plurality of image forming apparatus.

4. An image forming system according to claim 1, wherein the control unit in advance determines a difference in the environmental information between the environment detecting device of the one of the plurality of image forming apparatus and the environment detecting device of the another of the plurality of image forming apparatus, and wherein the control unit sets the image forming conditions of the one of the plurality of image forming apparatus based on the difference determined in advance and the environmental information of the another of the plurality of image forming apparatus.

5. An image forming system according to claim 1, wherein the image forming conditions which are set by the control unit of the one of the plurality of image forming apparatus comprise at least one set value selected from the group consisting of a charging bias which is applied to a charging device, a developing bias which is applied to a developer carrying member, a transfer bias which is applied to a transfer device, a fixing bias which is applied to a fixing unit, and a controlled fixing temperature of the fixing unit.

6. An image forming apparatus configured to form an image on a recording medium, the image forming apparatus comprising:
an environment detecting device configured to detect environmental information of the image forming apparatus;
a control unit configured to control image forming conditions based on the environmental information detected by the environment detecting device; and
a communication device configured to obtain at least the environmental information from another image forming apparatus,
wherein the control unit sets the image forming conditions based on environmental information of the another image forming apparatus through the communication device.

7. An image forming apparatus according to claim 6, wherein the control unit comprises a storage unit configured to store the environmental information detected by the environment detecting device, and
wherein the control unit determines a day having environmental information equivalent or close to the environmental information detected by an environment detecting device of the another image forming apparatus from the environmental information stored in a storage unit of the another image forming apparatus, and the control unit sets the image forming conditions based on the environmental information stored in the storage unit of the image forming apparatus on the day determined by the control unit.

8. An image forming apparatus according to claim 6, further comprising a holding unit configured to hold positional information of the main body,
wherein the control unit selects the another image forming apparatus based on the positional information and sets the image forming conditions based on the environmental information of the selected another image forming apparatus.

9. An image forming apparatus according to claim 6, wherein the control unit in advance determines a difference in the environmental information between the environment detecting device and an environment detecting device of the another image forming apparatus, and wherein the control unit sets the image forming conditions based on the difference determined in advance and the environmental information of the another image forming apparatus.

10. An image forming apparatus according to claim 6, wherein the image forming conditions comprise at least one of a charging bias which is applied to a charging device, a developing bias which is applied to a developer carrying member, a transfer bias which is applied to a transfer device, a fixing bias which is applied to a fixing unit, and a controlled fixing temperature of the fixing unit.
